(19) United States
(12) Patent Application Publication
(10) Pub. No.: US 2016/0140880 A1
(43) Pub. Date: May 19, 2016

(54) Tool with Indicia

(71) Applicant: Hong Ann Tool Industries Co., Ltd., Taichung City (TW)

(72) Inventor: Cheng-Wei Su, Taichung City (TW)

(21) Appl. No.: 14/805,530

(22) Filed: Jul. 22, 2015

(30) Foreign Application Priority Data
Nov. 18, 2014 (TW) 103139870

(51) Int. Cl. G09F 3/02; B25B 13/56; B25G 1/00

(52) U.S. Cl. CPC G09F 3/02; B25G 1/00; B25B 13/56; G09F 2003/0251; G09F 2003/0208

(57) ABSTRACT

A tool with indicia includes a main body extending longitudinally along a phantom axis and including a periphery thereof forming an indication area. An indicia device located on the indication area includes at least one seat mounted on the indication area, at least one indicia insert mounted on the at least one seat and forming indicia on opposite sides of the at least one seat with respect to the main body, and a ring injection molded to the at least one seat and the at least one indicia insert. The ring surrounds the outline of the at least one indicia insert. The ring includes at least one through hole and the indicia is exposed from the at least one through hole. The ring covers the at least one seat.

### BACKGROUND OF THE INVENTION

1. Field of the Invention

The present invention relates to a tool with indicia and, particularly, to a tool with indicia which can be assembled, in an easy manner, on the tool.

2. Description of the Related Art

TW Pat. No. M358039 shows a tool, an insert bit, with indicia which identifies the tool. The tool includes a body having a first section with a first injection-molded identification portion. The first identification portion has an area and an identification region delimited by the area. The area is covered by a second injection-molded identification portion. The second injection-molded identification portion and the identification region are different in height and the identification region has a hollow-out effect. The tool uses the first and second identification portions and the identification region to enhance its identification.

As set forth, the tool is injection-molded twice and can't be fabricated easily. In addition, the molds are costly.

The present invention is, therefore, intended to obviate or at least alleviate the problems encountered in the prior art.

### SUMMARY OF THE INVENTION

According to the present invention, a tool with indicia includes a main body extending longitudinally along a phantom axis and including a periphery thereof forming an indication area. An indicia device located on the indication area includes at least one seat mounted on the indication area, at least one indicia insert mounted on the at least one seat and forming indicia on opposite sides of the at least one seat with respect to the main body, and a ring injection molded to the at least one seat and the at least one indicia insert. The ring surrounds the outline of the at least one indicia insert. The ring includes at least one through hole and the indicia is exposed from the at least one through hole. The ring covers the at least one seat.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an objective of the present invention to provide a tool with indicia.

It is another objective of the present invention that the indicia can be assembled, in an easy and secured manner, to the tool.

It is yet another objective of the present invention to reduce the cost and complexity of molding.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a tool with indicia in accordance with a first embodiment of the present invention.

FIG. 2 is a perspective view showing the tool with indicia of FIG. 1 including an indicia device which includes a seat connected to the tool and an indicia insert connected to the seat.

FIG. 3 is an exploded perspective view of FIG. 2.

FIG. 4 is a cross-sectional view showing the indicia device and the tool shown in FIG. 2 disposed in an injection mold.

FIG. 5 is a cross-sectional view showing the indicia device and the tool shown in FIG. 2 disposed in an injection mold.

FIG. 6 is a partial enlarged view of FIG. 5.

FIG. 7 is a cross-sectional view showing an injection-molded ring of the indicia device shown in FIG. 1 surrounding the outline of the indicia insert and overlaying the seat, with the seat disposed between the ring and a periphery of the tool.

FIG. 8 is a perspective view of a tool with indicia in accordance with a second embodiment of the present invention.

FIG. 9 is an exploded perspective view showing the tool with indicia of FIG. 8 including an indicia device which includes a seat adapted to be connected to the tool and receive an indicia insert.

FIG. 10 is a perspective view of a tool with indicia in accordance with a third embodiment of the present invention.

FIG. 11 is a perspective view of a tool with indicia in accordance with a fourth embodiment of the present invention.

### DETAILED DESCRIPTION OF THE INVENTION

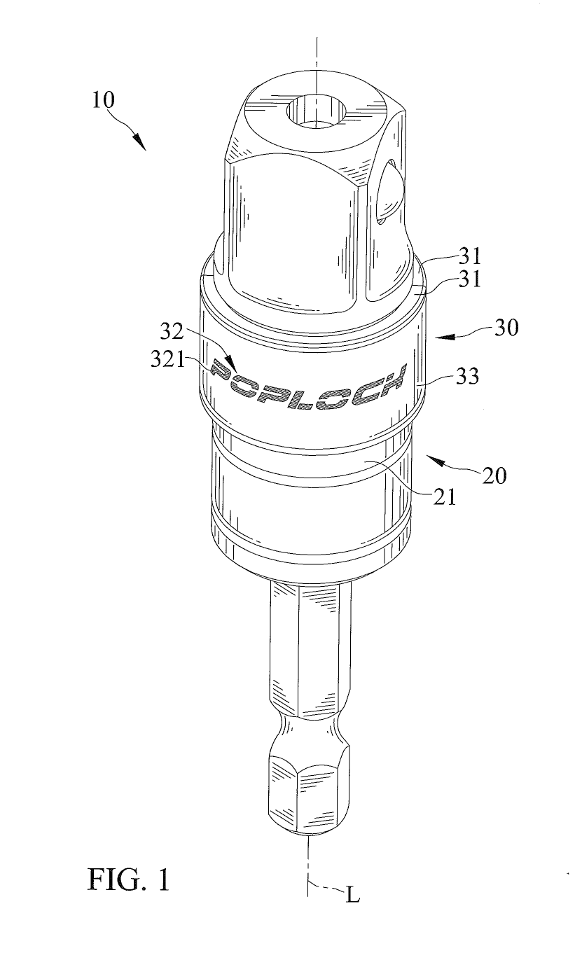

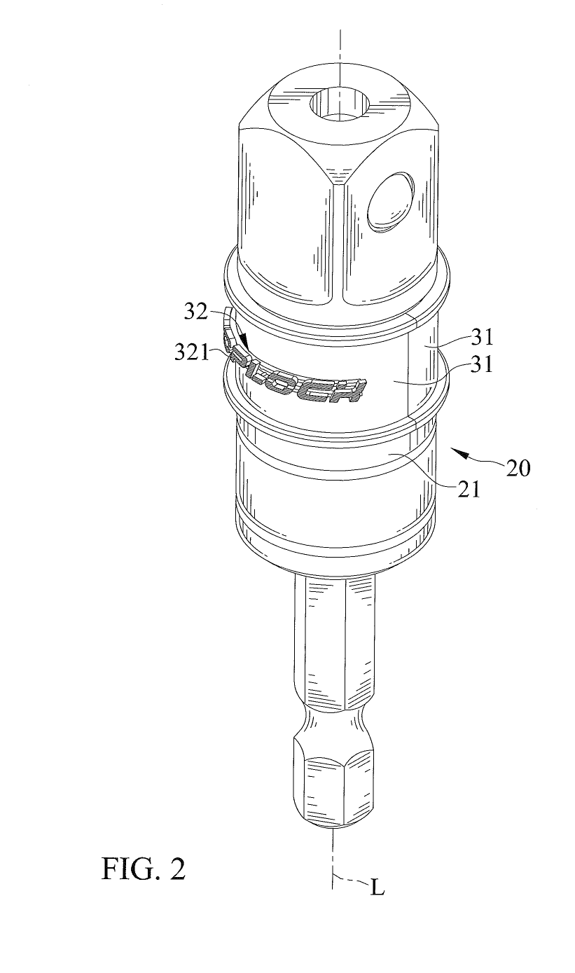

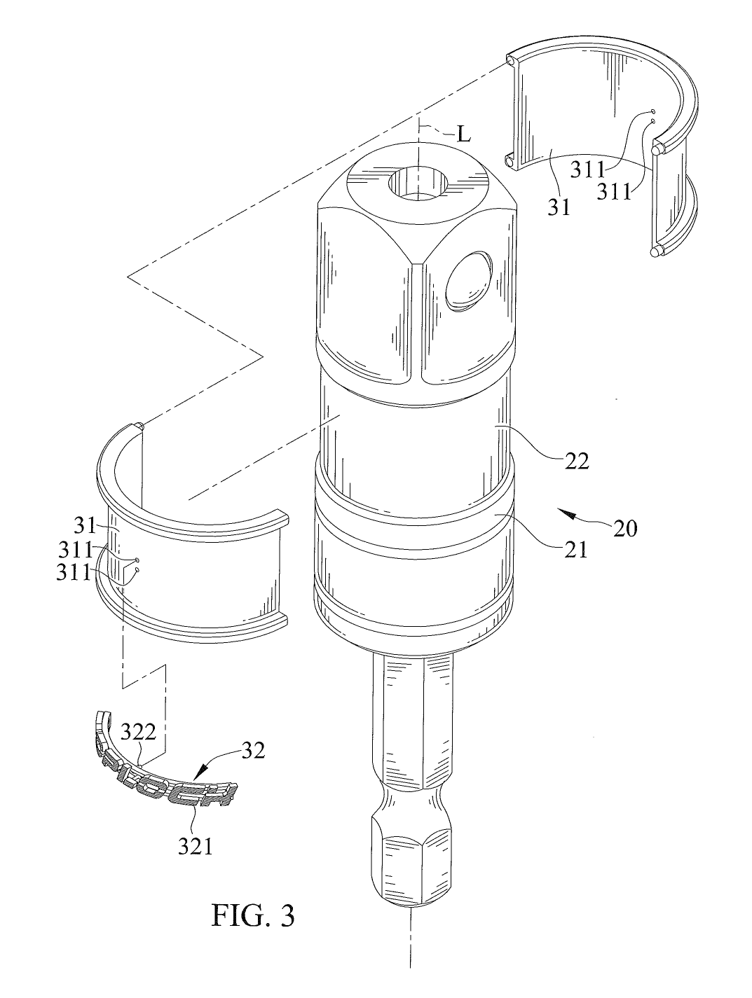

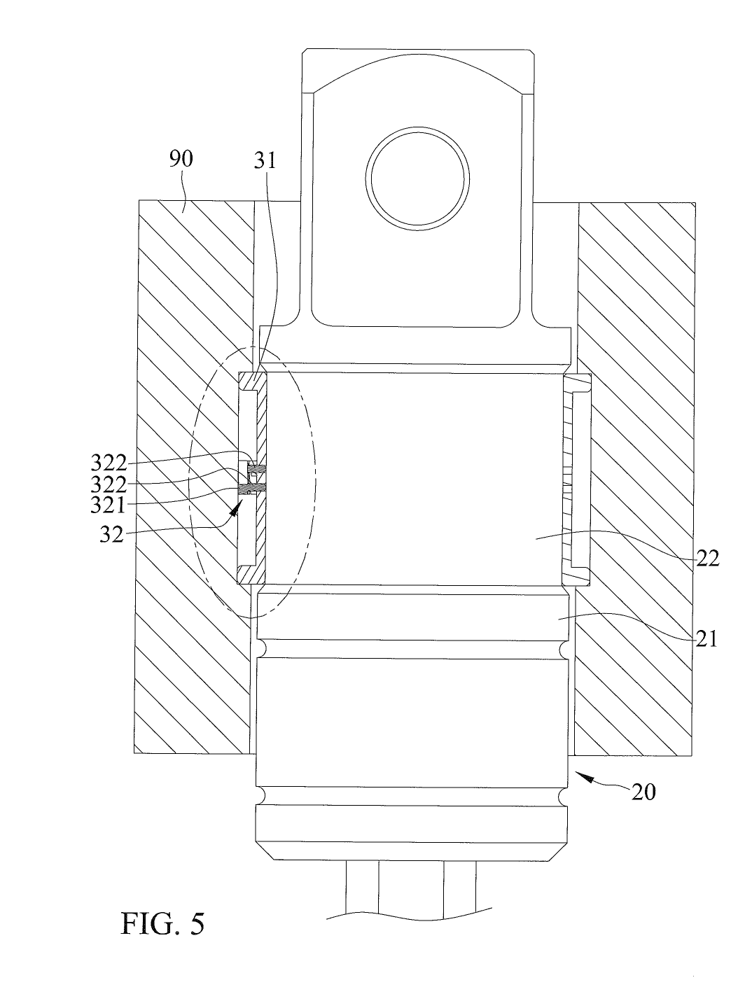

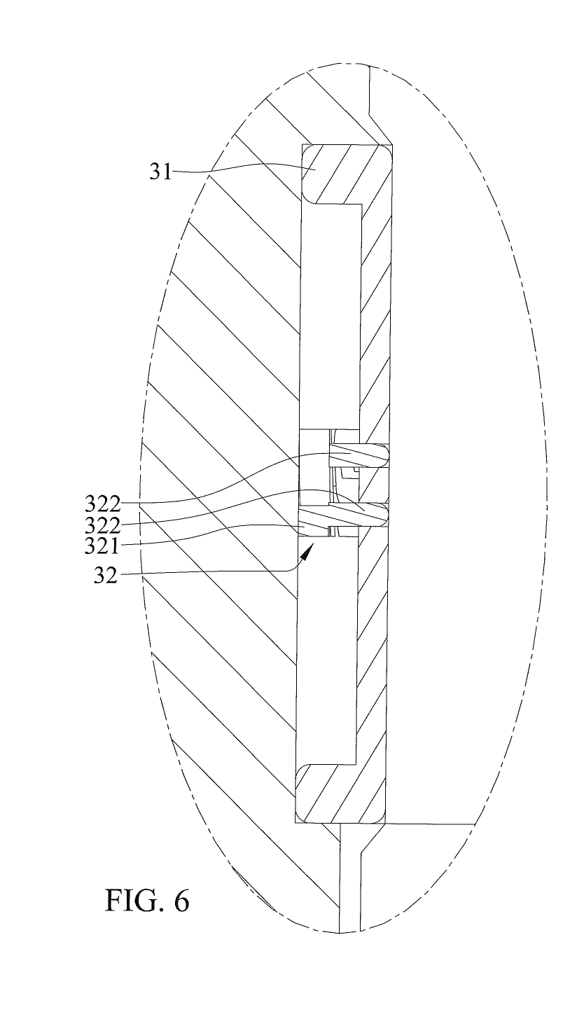

FIGS. 1 through 7 show a tool 10 with indicia in accordance with a first embodiment of the present invention. The tool 10 is a drive extension, but not limiting. The tool 10 includes a first distal end defining a first connecting end and a second distal end defining a second connecting end, respectively. As shown in FIG. 1, the first connecting end includes a polygonal periphery and a recess in the middle and the second connecting end includes a detent ball. The first and second connecting ends can connect tools.

The tool 10 with indicia includes a main body 20 and an indicia device 30.

The main body 20 extends longitudinally along a phantom axis L. The main body 20 includes a periphery thereof forming an indication area 22. The indication area 22 forms a recess on an outer periphery 21 of the main body 20. The recess is disposed between two outer peripheral sections. The recess has a width, measured in a direction radial to the phantom axis L, smaller than the two outer peripheral sections. The indication area 22 has a longitudinal length along the phantom axis L and a lateral length transverse to the phantom axis L. The indication area 22 includes the lateral length thereof extending curvedly. The indication area 22 extends annularly.

The indicia device 30 is located on the indication area 22. The indicia device 30 includes at least one seat 31, at least one indicia insert 32, and a ring 33.

The at least one seat 31 is mounted on the indication area 22. The at least one seat 31 has two ends and extends longitudinally in a direction of the phantom axis L between the two ends. The at least one seat 31 includes each of the two ends thereof having a width, measured in a direction radial to the phantom axis L, greater than a region extending between the two ends. The at least one seat 31 includes the region thereof forming a recess between the two ends thereof. The at least one seat 31 includes the region thereof having a lateral length transverse to a direction of the phantom axis L. The lateral length of the region of the at least one seat 31 extends curvedly transversely and have the same curvature as that of the indication area 22. The at least one seat 31 includes a plurality of seats 31 cooperating together. The plurality of seats 31 is arranged annularly on the indication area 22 and radially to the phantom axis L. The plurality of seats 31 completely surrounds the indication area 22. The at least one seat 31 includes two seats 31.

The at least one indicia insert 32 is mounted on the at least one seat 31 and forms indicia 321 on opposite sides of the at least one seat 31 with respect to the main body 20. The indicia 321 include one or more of raised letters, numerals, symbols, characters, designs, logos, pictures, or decorations. The at least one seat 31 includes at least one slot 311 and the at least one indicia insert 32 includes at least one projection 322 engaged in the at least one slot 311 to mount on the at least one seat 31. The at least one indicia insert 32 is disposed on the region of the at least one seat 31. The at least one indicia inserts 32 includes two indicia inserts 32. One indicia insert 32 is mounted on one seat 31 and the other indicia insert 32 is mounted on the other seat 31. The at least one through hole 331 includes two through holes 331. One indicia insert 32 is exposed from one through hole 331 and the other indicia insert 32 is exposed from the other through hole 331.

The ring 33 is injection molded to the at least one seat 31 and the at least one indicia insert 32. The ring 33 is injection molded into the region of the at least one seat 31. The injection-molded ring 33 can be easily molded to the at least one seat 31 and the at least one indicia insert 32 since the at least one seat 31 and the at least one indicia insert 32 are made of plastic. The at least one seat 31 and the at least one indicia insert 32 are, for example, made of polypropylene. The ring 33 is made of thermoplastic rubber.

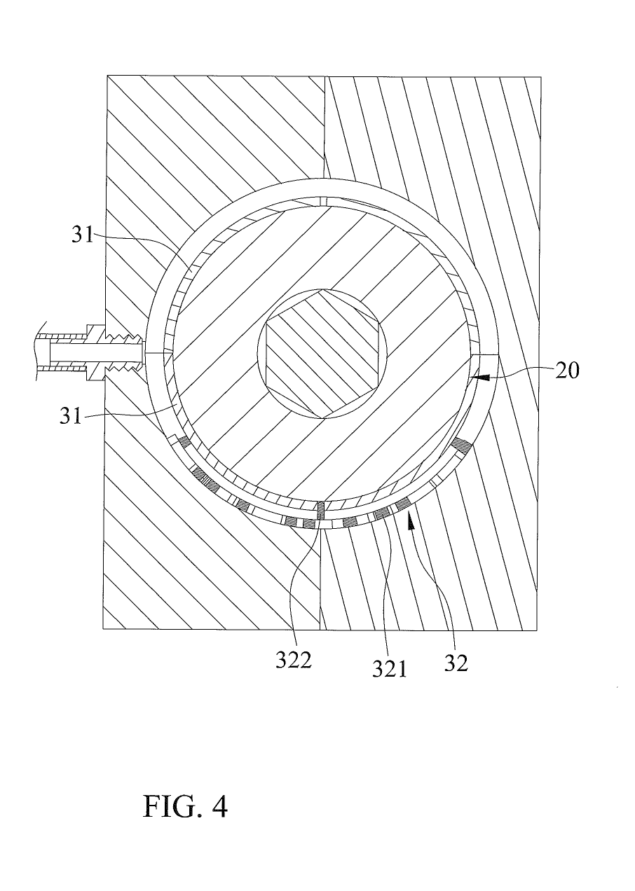

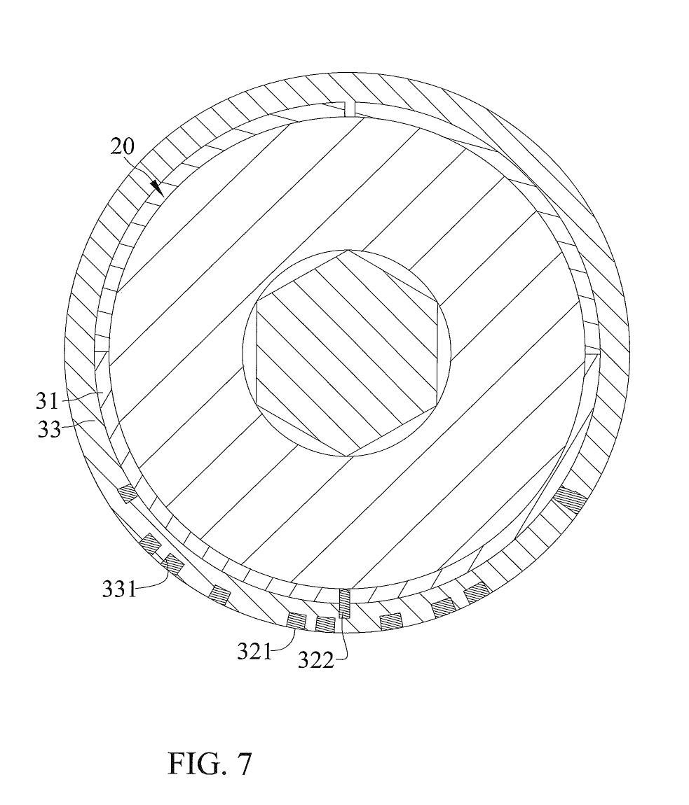

FIGS. 4 through 7 show the main body 20, the at least one seat 31, and the at least one indicia insert 32 disposed in a mold 90 and the ring 33 injection molded to the at least one seat 31 and the at least one indicia insert 32. FIGS. 1 and 7 show the ring 33 surrounding the outline of the at least one indicia insert 32 and covering the at least one seat 31. In addition, the ring includes at least one through hole 331 and the indicia 321 is exposed from the at least one through hole 331. In the final product, the ring 33 is flush with the two ends of the at least one seat 31 to provide a more aesthetic and neat look.

As used in this specification and claims, the term “indicia” refer to any mark intended to convey information to the viewer. For example, indicia may include letters, numerals, symbols, characters, designs, logos, pictures, decorations, shapes, geometries, textures, colors or combinations thereof, among other means of relaying information to the viewer.

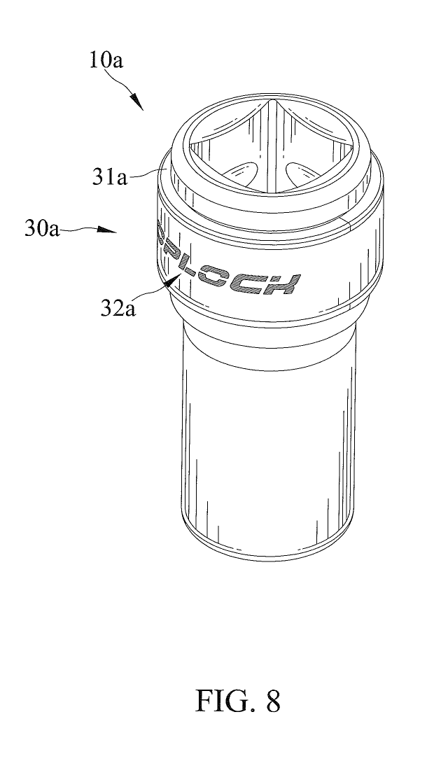

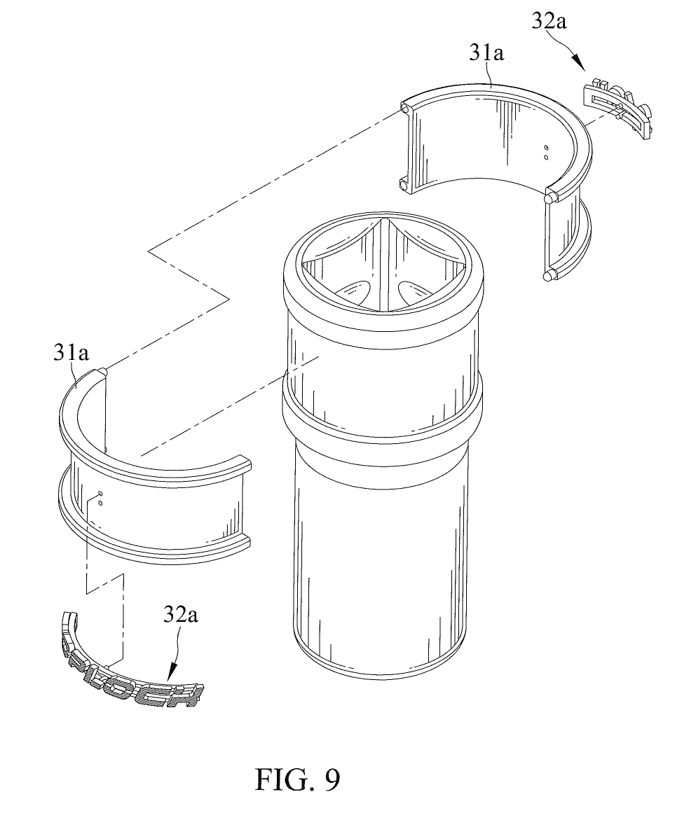

FIGS. 8 and 9 show a tool 10a with indicia in accordance with a second embodiment of the present invention, and same numbers are used to correlate similar components of the first embodiment, but bearing a letter a. The second embodiment is similar to the first embodiment except that the tool 10a is a socket. The tool 10a includes a main body thereof including an indication area of the same shape as the indication area 22 of the tool 10. Furthermore, the tool 10a includes an indicia device 30a the same as the indicia device 30. Likewise, the indicia device 30a includes an indicia insert 32a the same as the indicia insert 32.

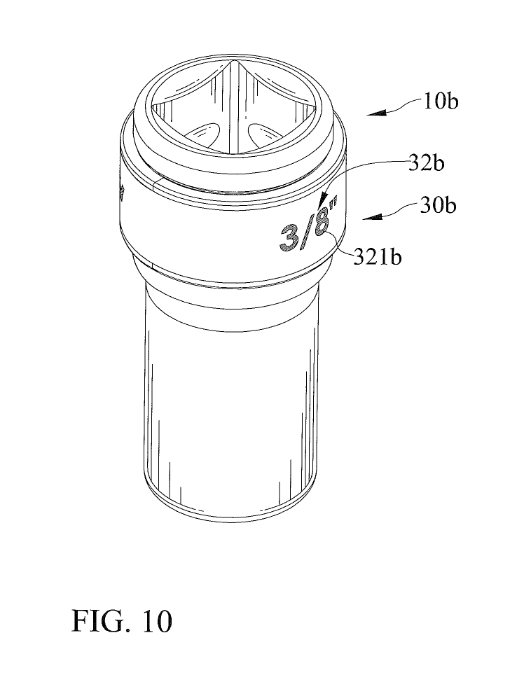

FIG. 10 shows a tool 10b with indicia in accordance with a third embodiment of the present invention, and same numbers are used to correlate similar components of the first embodiment, but bearing a letter b. The third embodiment is similar to the second embodiment except that an indicia device 30c includes an indicia insert 32b including indicia 321b of different outlines. The indicia 321b use numerals.

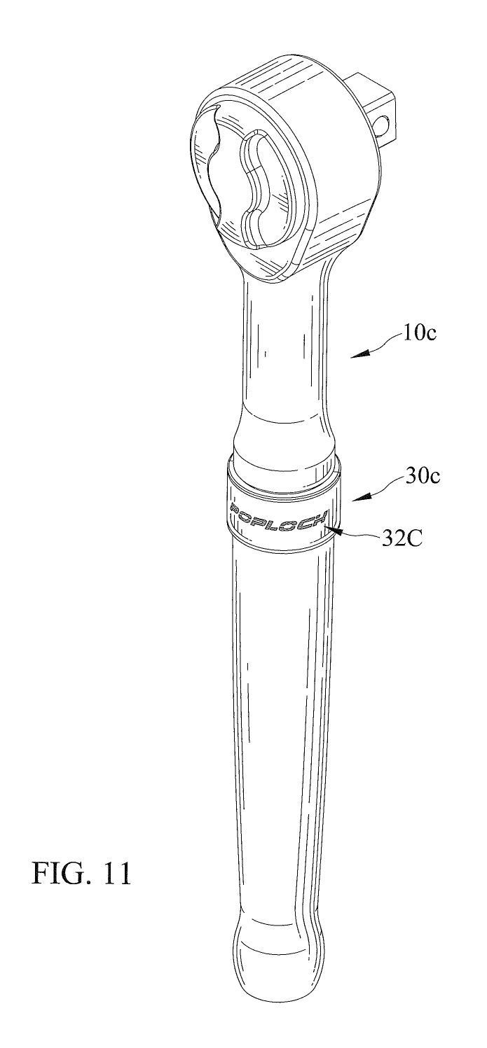

FIG. 11 shows a tool 10c with indicia in accordance with a fourth embodiment of the present invention, and same numbers are used to correlate similar components of the first embodiment, but bearing a letter c. The fourth embodiment is the similar to the first embodiment except that the tool 10c is a wrench. The wrench includes a first end thereof forming a handle and a second end thereof forming a driving end. The driving end includes a detent ball. The tool 10c includes a main body thereof including an indication area of the same shape as the indication area 22 of the tool 10. Furthermore, the tool 10c includes an indicia device 30c the same as the indicia device 30. Likewise, the indicia device 30c includes an indicia insert 32c the same as the indicia insert 32.

In view of the forgoing, the indicia device 30, 30a, 30b, and 30c can be assembled, in an easy and secured manner, to the tools 10, 10a, 10b, and 10c, respectively. Furthermore, the cost and complexity of molding with respect to convention tools with indicia are reduced.

The foregoing is merely illustrative of the principles of this invention and various modifications can be made by those skilled in the art without departing from the scope and spirit of the invention.

What is claimed is:

1. A tool with indicia comprising:
a main body extending longitudinally along a phantom axis and including a periphery thereof forming an indication area; and
an indicia device located on the indication area including at least one seat mounted on the indication area, at least one indicia insert mounted on the at least one seat and forming indicia on opposite sides of the at least one seat with respect to the main body, and a ring injection molded to the at least one seat and the at least one indicia insert, with the ring surrounding the outline of the at least one indicia insert, with the ring including at least one through hole and the indicia exposed from the at least one through hole, and with the ring covering the at least one seat.

2. The tool with indicia as claimed in claim 1, wherein the at least one seat has two ends and extends longitudinally in a direction of the phantom axis between the two ends, wherein the at least one seat includes each of the two ends thereof having a width, measured in a direction radial to the phantom axis, greater than a region extending between the two ends, and wherein the region forms a recess and at least one indicia insert is disposed on the region.

3. The tool with indicia as claimed in claim 2, wherein the indication area of the main body and the region of the at least one seat extend curvedly transversely and have the same curvature.

4. The tool with indicia as claimed in claim 2, wherein the ring is injection molded into the region.

5. The tool with indicia as claimed in claim 1, wherein the at least one seat includes a plurality of seats cooperating together.

6. The tool with indicia as claimed in claim 5, wherein the plurality of seats is arranged annularly on the indication area and radially to the phantom axis, and wherein the indication area is completely surrounded by the plurality of seats.

7. The tool with indicia as claimed in claim 1, wherein the at least one seat includes at least one slot and the at least one indicia insert includes at least one projection engaged in the at least one slot to mount on the at least one seat.

8. The tool with indicia as claimed in claim 1, wherein the indication area forms a recess on an outer periphery of the main body, wherein the recess is disposed between two outer peripheral sections, and wherein the recess has a width, measured in a direction radial to the phantom axis, smaller than the two outer peripheral sections.

9. The tool with indicia as claimed in claim 8, wherein the at least one seat has two ends and extends longitudinally in a direction of the phantom axis between the two ends, wherein the at least one seat includes each of the two ends thereof having a width, measured in a direction radial to the phantom axis, greater than a region extending between the two ends, and wherein the region forms a recess and at least one indicia insert is disposed on the region.

10. The tool with indicia as claimed in claim 9, wherein the ring is injection molded into the region.

11. The tool with indicia as claimed in claim 1, wherein the at least one seat, the at least one indicia insert and the ring are made of plastic.

12. The tool with indicia as claimed in claim 10, wherein the at least one seat and the at least one indicia insert are made of polypropylene, and wherein the ring is made of thermoplastic rubber.

13. The as claimed in claim 1, wherein the indicia include one or more of raised letters, numerals, symbols, characters, designs, logos, pictures, or decorations.
